(19) United States
(12) Patent Application Publication
(10) Pub. No.: US 2025/0339990 A1
(43) Pub. Date: Nov. 6, 2025

(54) JOINERY JIG FOR TABLE SAW AND ROUTER TABLE

(71) Applicant: Cook Products LLC, Mt. Sidney, VA (US)

(72) Inventor: Wesley Brent Cook, Mt. Sidney, VA (US)

(21) Appl. No.: 19/194,267

(22) Filed: Apr. 30, 2025

Related U.S. Application Data
(60) Provisional application No. 63/641,442, filed on May 2, 2024.

(51) Int. Cl. B27F 1/08; B27B 25/10; B27C 5/06; B27F 5/02

(52) U.S. Cl. CPC B27F 1/08; B27B 25/10; B27F 5/02; B27C 5/06

(57) ABSTRACT

A jig assembly includes jig body having a front side, a top side, a bottom side, a left side, and a right side, the top side and the bottom side being parallel to each other, the left side and the right side being parallel to each other, and the front side being perpendicular to the top side and bottom side. A lower carriage support is connected to a lower portion of the front side, and an upper carriage support is removably coupled to an upper portion of the front side. A pinion is connected to a top of the top side, the pinion configured to spin freely about an axle, and a pinion axle bracket is connected to a back of the front side above the pinion.

### CROSS-REFERENCE TO RELATED APPLICATION

This application claims priority from and the benefit of U.S. Provisional Patent Application No. 63/641,442, filed on May 2, 2024, which is hereby incorporated by reference for all purposes as if fully set forth herein.

### BACKGROUND

### Field

Exemplary embodiments relate to a joinery jig for table saw and router table.

### Discussion of the Background

Currently, there are a number of solutions for providing a joinery jig for woodworking that allows an operator to produce joinery on a table saw or router table. Some of these jigs attempt to facilitate clamping of workpiece(s), moving of workpiece(s) while clamped, and indexing the orientation of workpiece(s) relative to a cutter to remove material from said workpiece(s) at known consistent intervals, but these solutions fail to meet the needs of the industry because clamping workpiece(s) can normally only safely be done in one orientation relative to the jig, clamps are not be held by or not integral to the jig which makes clamping cumbersome and dangerous should clamps loosen during operation, and workpiece(s) cannot be moved relative to the associated cutter without reclamping/repositioning said workpiece(s) relative to the jig or readjusting/recalibrating the entire jig relative to the cutter. For these reasons, current solutions are limited in the size(s) and orientation(s) of workpiece(s) they can safely accommodate and fail to provide versatility in the types of joinery they can produce.

Furthermore, current solutions do not allow the operator to calibrate the amount of material removal from workpiece(s) without a separate measuring/calibrating device which results in greater set-up time and greater inaccuracy and/or accumulated error relative to the desired amount of material to be removed. Current solutions also attempt to promote operator safety, but these solutions are similarly unable to meet the needs of the industry because operators may be inclined to have a hand, arm, or portion of the body directly in line of a spinning cutter during operation or are inclined/limited to use hands for holding the workpiece during operation.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a joinery jig for woodworking that can produce various types of joinery with, but not limited to, a table saw or router table that can eliminate the need for multiple custom made or commercially available joinery jigs that facilitate the production of only one type, or limited types, of joinery. Furthermore, exemplary embodiments have a woodworking joinery jig that facilitates fast and safe workpiece clamping, fast and safe clamping of multiple workpieces, fast and accurate calibration, fast and safe workpiece relocation for multiple passes across a cutter for the purpose of removing material without re-clamping workpieces or re-adjusting the joinery jig, fast and safe clamping of workpiece(s) in different orientations with respect to an associated cutter, and that has no cutting depth restrictions.

Exemplary embodiments also provide a woodworking joinery jig that encourages operator safety by allowing operator's hands, arms, and body to remain entirely to one side of the power cutter during operation, and having an integral anti-tip mechanism to prevent the joinery jig from tipping when partially overhanging the power cutter's work surface. Exemplary embodiments of the inventive concept and associated method advantageously fill these needs and addresses the aforementioned deficiencies by providing a fast and accurate method of clamping, a fast and accurate method of calibration, and a fast and accurate method of workpiece relocation without re-clamping while not limiting the operator to one type, or limited types, of joinery and promoting and allowing for a high degree of operator safety.

Additional aspects will be set forth in the detailed description which follows, and, in part, will be apparent from the disclosure, or may be learned by practice of the inventive concept.

According to exemplary embodiments, a jig assembly includes jig body having a front side, a top side, a bottom side, a left side, and a right side, the top side and the bottom side being parallel to each other, the left side and the right side being parallel to each other, and the front side being perpendicular to the top side and bottom side. A lower carriage support is connected to a lower portion of the front side, and an upper carriage support is removably coupled to an upper portion of the front side. A pinion is connected to a top of the top side, the pinion configured to spin freely about an axle, and a pinion axle bracket is connected to a back of the front side above the pinion.

According to exemplary embodiments, a method of using a jig assembly to machine a workpiece includes providing a jig assembly comprising a jig body, a stock carriage, a rack and pinion mechanism, and a miter bar assembly, wherein the jig assembly is configured to be operatively coupled to a power cutter, clamping a workpiece to the stock carriage in a desired orientation relative to the stock carriage and the power cutter, calibrating a “0” point with a caliper coupled to the jig body, the caliper configured to track movement of the stock carriage relative to the power cutter, moving the clamped workpiece via the rack and pinion mechanism of the jig assembly to determine a bound range of stock carriage movement or a starting or stopping point of material removal from the workpiece without engaging the cutter, setting and tightening one or more adjustable T-slot stops or carriage stop assemblies in the T-slot of the stock carriage according to the calibrated range of material removal from the workpiece, and pushing the jig assembly forward and backward over or past the power cutter. Material is removed from the workpiece only on the forward motion or as the jig is pushed away from a user until a desired amount of material is removed from the workpiece.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 shows a perspective view of a joinery jig according to an exemplary embodiment.

FIG. 2 shows a perspective view of a stock carriage and a jig body of the joinery jig of FIG. 1.

FIG. 3 shows a perspective view of the stock carriage of the joinery jig of FIG. 1.

FIG. 4 shows a perspective view of the jig body of the joinery jig of FIG. 1.

FIG. 5 shows a perspective view of the jig body of FIG. 4.

FIG. 6 shows a side view of the jig body of FIG. 4.

FIG. 7 shows another perspective view of the joinery jig of FIG. 1.

FIG. 8 shows a side of a handle assembly of the jig body of FIG. 5.

FIG. 9 shows a perspective view of a pinion clutch/clutch lever mechanism of the handle assembly of FIG. 8.

FIG. 10A and FIG. 10B show side views of the pinion clutch/clutch lever mechanism of FIG. 9.

FIG. 11 shows a top view of the joinery jig of FIG. 1.

FIG. 12 shows a perspective view of workpieces clamped to a joinery jig according to an exemplary embodiment.

FIG. 13 shows a perspective view of the joinery jig of FIG. 12.

FIG. 14 shows a perspective view of a joinery jig according to an exemplary embodiment.

FIG. 15 shows a perspective view of the joinery jig of FIG. 14.

FIG. 16 shows a perspective view of a pinion clutch/clutch lever mechanism according to an exemplary embodiment.

FIG. 17 shows another perspective view of the pinion clutch/clutch lever mechanism of FIG. 16.

FIG. 18 shows a perspective view of a lower carriage of a jig body according to an exemplary embodiment.

FIG. 19 shows another perspective view of the jig body of FIG. 18.

FIG. 20 shows a perspective view of a pinion axle bracket and a pinion axle of a joinery jig according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. This disclosure may, however, be embodied in different forms and should not be construed as limited to the exemplary embodiments set forth herein. Various embodiments may be practiced without these specific details or with one or more equivalent arrangements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments disclose a woodworking joinery jig for a table saw and router or shaper table, which is made up of the following components: a rectangular stock carriage containing a plurality of T-slots, commonly known in the industry as “T-track”, “T-track fence”, or “Multitrack” that has a removable or permanently affixed rack; a caliper; a caliper hold-down assembly for coupling the caliper to the stock carriage; a jig body having a front, top, bottom, left, and right side with the top side and bottom side being parallel with respect to each other and with the left side and right side being parallel with respect to each other, the front side having a lower support and a detachable upper support, the front side being perpendicular to the bottom and top sides; a pinion that is retained by the jig body via an axle through its center but able to rotate about said axle; a pinion axle bracket that is coupled to the front side of the jig body which retains the top end of the pinion axle; a handle assembly retained by the jig body via the same axle around which the pinion rotates, the handle being able to pivot freely and having an internal clutch which engages the pinion and an internal lever which forces the clutch toward the pinion; a caliper jaw lock assembly that couples one of the caliper jaws to the front side of the jig body; and a miter bar secured to the bottom of the bottom side of the jig body.

These components are connected as follows: the stock carriage couples to the jig body via the lower and upper carriage supports which are coupled to the front side of the jig body, the caliper is coupled to the top of the stock carriage via the caliper hold-down assembly with one of its jaws coupled to the caliper jaw lock assembly which is attached to the front side of the jig body, the pinion and handle assembly are coupled to the jig body via the pinion axle which is secured in position via the pinion axle bracket and receiving hole in the top side of the jig body.

Exemplary embodiments may also have one or more of the following: a workpiece guide stop that is coupled to the front of the stock carriage perpendicularly so that an edge or face of different workpieces may be clamped to the stock carriage in the same location relative to the stock carriage; a workpiece guide stop containing T-slots to clamp workpieces perpendicular to the stock carriage; a workpiece guide stop that allows for clearance of one or more T-slots in the front of the stock carriage so that T-slot clamps may be inserted in said T-slots, bypassing said workpiece guide stop, for workpiece clamping purposes; a workpiece clamping guide that couples to the stock carriage for clamping workpieces at angles other that 90 degrees relative to the associated power cutter's work surface, said clamping guide may have an adjustable heel for clamping workpieces at any angle; an indexing mechanism that may lock into a parallel miter slot of the associated power cutter's work surface for moving the stock carriage a known distance repeatably without the use of the dial caliper, said indexing mechanism may use tabs or pins to fill the void of removed material for the purpose of indexing by either manual adjustment or threaded rod adjustment; a mirror affixed to an adjustable support mechanism that may be coupled to the stock carriage or to the jig body to allow operator to clearly see where cutter engages workpiece relative to layout markings on said workpiece, said mirror accessory may include a battery-powered light to aid in workpiece alignment relative to layout markings in low-light conditions and/or a magnifying glass to prevent operator from leaning over the associated power cutter's work surface to confidently see layout markings; stops that lock into T-slots on the front of the stock carriage for aligning workpieces at a desired angle or orientation before clamping; stops that lock into T-slots on the cleats of the stock carriage to provide a known calibrated location or create a bound range of stock carriage movement; pop-up or bypass stops that lock into the T-slots of the stock carriage to allow multiple range-bound regions of stock carriage movement; T-slot stop bypass mechanisms affixed to jig body to allow for multiple range-bound regions of stock carriage movement; a dust collection port that easily couples to and uncouples from the jig body; a removable storage drawer or container for accessories that is located in the space created by the top, bottom, left, right, and front sides of the jig body, said drawer or container may couple to and decouple from the front side of the jig housing via magnets or spring-assisted latch; a miter bar that is rabbeted to prevent jig from tipping when partially overhanging the work surface of the associated power cutter; a miter bar that allows the jig body to rotate relative to the associated power cutter such as a standard miter gauge known in the industry; a stock carriage extension to hold a workpiece parallel to the associated power cutter's work surface; an electronic calibration device affixed to the jig body or stock carriage to track stock carriage movement via digital read-out or varying audible tones; a piston and rod mechanism for moving the stock carriage relative to the jig body; a threaded rod mechanism for moving the stock carriage relative to the jig body; a system of radial or linear bearings for coupling the stock carriage to the jig body; a system of telescoping tracks via ball bearings for coupling the stock carriage to the jig body; and a system of telescoping tubing for moving the stock carriage relative to the jig body.

Components of the stock carriage, jig body, or aforementioned accessories of exemplary embodiments may be made of wholly or in part, but not limited to, machined aluminum, extruded aluminum, cast aluminum, wood, plywood, melamine, wood composite, high density polyethylene, plastic, acrylic, ultra-high molecular weight (UHMW) plastic, polyvinyl chloride, stamped steel, CNC stamped powder-coated steel, rubber, stainless steel, cold rolled steel, hot rolled steel, or machined cast iron.

Similarly, an associated method of using the joinery jig according to exemplary embodiments may also include one or more of the following steps: desired amounts and locations of material may be removed from workpiece(s) by tracking stock carriage movement via the caliper; desired amounts and locations of material may be removed from workpiece(s) by placing T-slot stops to bind stock carriage movement to a desired range or to a desired starting or stopping point relative to the associated power cutter; desired amounts and locations of material may be removed from workpiece(s) by calibrating an indexing mechanism, said mechanism may then be used to move the stock carriage by the same distance in the same direction repeatably without the use of a measuring device; and desired amounts and locations of material removal from workpiece(s) may be accomplished by a combination of any of the aforementioned methods.

Exemplary embodiments provide: an integrated clamping system which prevents clamps from falling into a spinning power cutter; an integrated clamping system that simplifies clamping and reduces set-up time; a clamping system that allows workpiece(s) to be clamped at many orientations for creating various types of joinery; a clamping system that accommodates various sizes of workpieces thus increasing versatility; and a clamping system that can accommodate multiple workpieces to decrease production time.

Similarly, the associated method allows workpiece(s) to be repositioned relative to a cutter without reclamping workpiece(s) for removing material incrementally by making multiple passes across a cutter thus increasing safety and decreasing production time; and allows workpiece(s) to be calibrated relative to a cutter for fast, accurate, and repeatable material removal without the use of a separate measuring device.

Similarly, the method according to exemplary embodiments: allows workpiece(s) to be moved within a bound range; allows workpiece(s) to be repeatably moved to a stopping point or from a starting point where desired material removal is terminated or began respectively; allows material to be removed from workpiece(s) at repeatable increments; and can position workpiece(s) at varying angles relative to the cutter further increasing joinery versatility.

Exemplary embodiments include: a rack and pinion mechanism that facilitates the moving of workpiece(s) to engage the associated cutter; a handle and clutch mechanism that affords the operator the mechanical advantage to easily and precisely turn the pinion in order to move the workpiece(s) relative to where said workpiece(s) will engage the associated cutter; an integral caliper that precisely tracks the movement of the workpiece(s) relative to where said workpiece(s) will engage the associated cutter; an arrangement of support pieces that secure the carriage, of which the workpiece(s) are clamped, to the jig body creating a “zero play” connection about the direction perpendicular to associated cutter's work surface's miter slot, but slideably moveable about the direction parallel to said carriage; adjustable T-slot stops that provide a bound range, starting point, or stopping point of carriage movement; and a carriage, to which the workpiece(s) are clamped, that can be coupled to the jig body at a desirable height above the associated cutter's work surface in order to clear the top of the cutter for most joinery needs or be quickly adjusted to a point where the cutter will not be able to engage the carriage, thus eliminated cutter height restrictions altogether.

Furthermore, the method according to exemplary embodiments: enables clamped workpiece(s) to be precisely calibrated relative to where said workpiece(s) will engage a cutter without a separate measuring or calibration device thus reducing set-up time and eliminating “trial and error” methodology; allows operator to quickly and precisely return the devise to a “zero” or starting point to clamp new workpiece(s) for repeatable production operations without recalibration; and eliminates and/or reduces the need for reclamping workpiece(s) or recalibrating the device during a given joinery procedure or production operation.

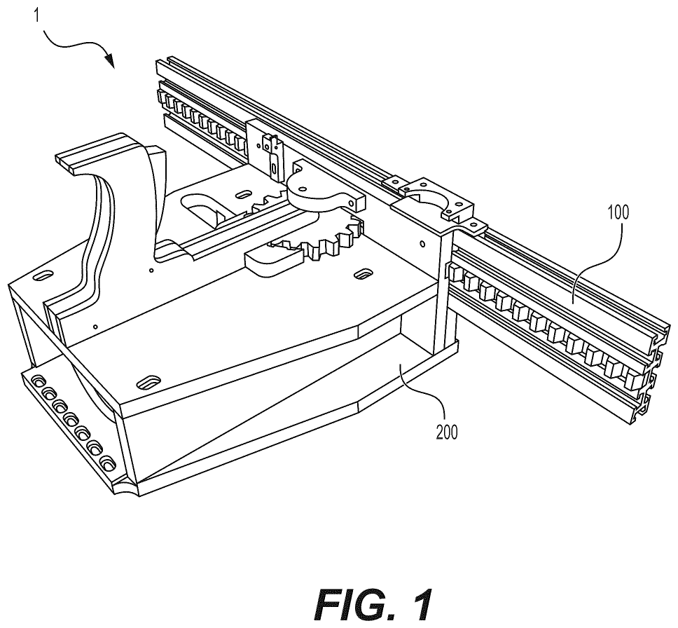

As shown in FIG. 1 a joinery jig 1 according to exemplary embodiments of the inventive concept is made up of two main assemblies: a stock carriage 100 and a jig body 200. The stock carriage 100 may be made up of the following components: a primary rectangular member having a plurality of T-slots on both its faces, a T-slot on its top side, a T-slot on its bottom side, and an integral rack on one face in an available T-slot; a detachable caliper; a caliper hold-down assembly; detachable carriage accessories with T-slots, i.e. shorter sections of the stock carriage embodiment minus an integral rack; angle brackets for attaching the carriage accessories; carriage stop assemblies; and stock clamping guide assemblies.

These components are related as follows: The caliper is coupled to the top edge of the stock carriage via the caliper hold-down assembly. The caliper hold-down assembly includes a caliper locking bar, a caliper base plate, and a caliper hold-down. The caliper locking bar slides into the T-slot on the top edge of the stock carriage and is sized to be retained by the T-slot but remain slidably adjustable. The caliper base plate is then coupled to the locking bar at a suitable location per an operator's desired operation thus “locking” the caliper locking bar and caliper base plate to the stock carriage. The caliper is then secured to the caliper base plate with the caliper hold-down. The caliper hold-down couples to the caliper base plate thus “clamping” the caliper to the caliper hold-down assembly, thus the stock carriage. The caliper hold down may also contain set screws to further secure the caliper to the caliper hold-down assembly.

The stock carriage accessories may be coupled perpendicularly to the stock carriage face or end via the angle brackets. The stock carriage accessories may also couple in a parallel fashion to the face or top edge of the stock carriage via carriage accessory locking bars and carriage accessory hold-down bars. The carriage accessory locking bars are sized to be retained by the T-slots but able to remain slidably adjustable; the carriage accessory hold-down bars are similarly sized. The carriage accessory locking bars are inserted into a desired T-slot on the stock carriage while the carriage accessory hold-down bars are inserted into a desired T-slot on a carriage accessory. The carriage accessory locking bars and the carriage accessory hold-down bars are then coupled in order to “clamp” the carriage accessory to the stock carriage at a desired location.

The carriage stop assemblies are comprised of a carriage stop locking bar and a carriage stop. The carriage stop locking bars are sized to be retained by a T-track but remain slidably adjustable. The carriage stops couple to the carriage stop locking bars in order to “clamp” the carriage stop assemblies to the stock carriage at desired locations for calibration or references for clamping workpieces to the stock carriage. The stock clamping guide assemblies are comprised of locking bars sized according to the carriage accessory locking bars and a clamping guide which is, but not limited to, a rectangular member with a slot. When used with two carriage accessory locking bars, the clamping guide may be “clamped” to the stock carriage or a carriage accessory at a desirable angle for positioning workpiece(s) before clamping.

The jig body may be made up of the following components: a front, top, bottom, left, and right side, the top and bottom being parallel with respect to one another, the left and right being parallel with respect to one another, and the front being perpendicular with respect to the top and bottom; a lower carriage support; an upper carriage support; a pinion; an axle; a pinion axle bracket; a handle; a pinion clutch; a clutch lever; a pinion clutch/clutch lever coupling pin; a clutch lever retaining pin; an extension spring; an extension spring retaining pin; a caliper jaw lock; an accessory storage container; and a miter bar assembly.

These components are related as follows: the lower carriage support is affixed to the lower portion of the front side. The upper carriage support is removably coupled to the upper portion of the front side on the same face as the lower carriage support. The upper carriage support can be tightened to/loosened from the front face for inserting/removing the stock carriage. The pinion axle bracket is affixed to the back of the front side above the pinion. The pinion is located on the top of the top side which spins freely about the axle. The axle is retained by the pinion axle bracket and a coaxial hole in the top side. The pinion protrudes through the front of the front side to engage, or “mesh” with the teeth of the rack of the stock carriage. The caliper jaw lock is adjustably coupled to the back of the front side adjacent to the pinion axle bracket. The caliper jaw lock is mounted perpendicular to the top side and couples the moveable jaw of the caliper to the jig body on its upper range of its adjustability and uncouples the moveable jaw of the caliper from the jig body at the lower range of its adjustability. The caliper jaw lock contains a “tab” for engaging one side of the movable caliper jaw and a hole in which an allen wrench is inserted to engage the opposing side of the movable caliper jaw. The allen wrench is then secured by a set screw that threads into the caliper jaw lock thus “locking” the moveable caliper jaw to the jig body allowing the caliper to track distance the stock carriage moves then the pinion is rotated.

The handle is retained to the jig body via the axle and pivots freely about said axle. The handle is notched over the pinion to reach the axle. The handle houses the pinion clutch and clutch lever. The pinion clutch protrudes from the bottom of the handle adjacent to the pinion to engage the pinion teeth or spokes when the clutch lever is pressed into the handle. The pinion clutch and clutch lever are coupled via the pinion clutch/clutch lever coupling pin through the knuckles of said pinion clutch and clutch lever and the clutch lever is coupled to the handle via the clutch lever retaining pin which said clutch lever pivots about in a bound range providing a pivot point from which the pinion clutch may be forced toward the pinion. One end of the extension spring is retained in the handle via the extension spring retaining pin, the other end is retained by the pinion clutch/clutch lever coupling pin between the knuckles of the pinion clutch and clutch lever. The pinion clutch is pulled away from the pinion after the clutch lever is released via the extension spring, thus allowing the handle assembly to again rotate freely around the pinion; this also returns the clutch lever to its original position where it protrudes from the handle.

The miter bar is affixed to the bottom of the bottom side. It is attachable in multiple locations so that the jig body can be set to a desired location from associated power cutter. The miter bar can also be attached to bottom of the bottom side to allow the jig body to rotate relative to the miter bar via a removeable pin at one end of the miter bar and a thru bolt and locking knob at the opposing end of the miter bar, with the bolt protruding through the bottom of jig body allowing the locking knob to tighten onto the top of the bottom of the jig body. The jig body rotates relative to the miter bar in a bound range via an arced slot in the bottom side of the jig body through which the thru bolt in the miter bar can travel when the locking knob is loosened from the top of the bottom of the jig body. The accessory storage container can be stationed and removed from the enclosure created by the top, bottom, left side, right side, and front side of the jig body. It should further be noted that the stock carriage is coupled to the jig body with the detachable upper carriage support. After the bottom of the stock carriage is slid over the lower carriage support with the rack of the stock carriage engaged with the pinion on the jig body, the detachable upper carriage support is tightened to the front side of the jig body, thus drawing the stock carriage tight to the jig body.

The joinery jig includes an integrated movement and measurement system comprising a rack and pinion mechanism, a manually operable handle assembly with a clutch, and a linear caliper. This system enables controlled, precise advancement of a stock carriage relative to a jig body and associated cutting tool, while simultaneously tracking movement without requiring external measurement tools. The rack is affixed to a longitudinal surface of the stock carriage and engages with a pinion retained within the jig body. The pinion is rotatable about an axle and is configured to drive linear movement of the stock carriage when engaged. Rotation of the pinion translates the carriage along an axis parallel to the length of the rack, facilitating accurate positioning of the clamped workpiece relative to the cutter.

The handle is pivotally connected to the pinion axle and houses an internal clutch mechanism. The clutch includes a spring-biased pinion clutch that can be selectively engaged by pressing a clutch lever located on the handle. When engaged, the handle rotates the pinion to move the stock carriage. When the lever is released, the spring retracts the clutch, allowing the handle to rotate freely without moving the carriage. This design allows ergonomic repositioning of the handle and controlled movement when desired by a user.

A linear caliper is mounted between the jig body and the stock carriage to track displacement during movement. One jaw of the caliper is coupled to the stock carriage via a caliper hold-down assembly, and the opposing jaw is fixed to the jig body via a caliper jaw lock. As the pinion moves the stock carriage, the caliper provides real-time measurement of displacement from a zeroed position, enabling accurate calibration of cut depth, spacing, and repeatable operations. This integrated movement system offers numerous advantages, including eliminating the need for separate measuring tools, enabling repeatable cuts without reclamping, and maintaining operator safety by allowing hands to remain at a distance from the cutter. The system's coordinated operation improves workflow efficiency and supports high-precision joinery operations, including dovetails, finger joints, and mortises.

It should be further noted that the device may include an indexing accessory, a miter bar assembly, and angle stops. The indexing accessory includes (1) an indexing locking bar and (2) an indexing guide. The indexing accessory may be “clamped” in an adjacent, or unused miter slot to expand the capabilities of the disclosed device and method. The indexing locking bar is sized to be retained by, but remain slidably adjustable, in a standard “eared”, “tabbed”, or “undercut” miter track commonly used in the industry. The indexing guide is then coupled to the indexing locking bar thus “clamping” the indexing accessory to the miter track. The indexing accessory can then be used as a positive stop for positioning workpieces for material removal or have a fixed or adjustable “tab” or “pin” or “pins” that reference a void or notch in workpiece(s) so that workpiece(s) may be easily repositioned, or “indexed”, for equal notch spacing.

The miter bar assembly is comprised of (1) a miter bar and (2) a zero-tolerance bar. The miter bar embodies a plurality of holes, threaded and non-threaded, to specifically accommodate the jig body for use on equipment with standard miter tracks to increase the jigs' functions and ease of use. The zero tolerance bar is adjustable to make contact with one side of a miter track before coupling it to the miter bar which makes contact with the opposing side of a miter track, thus creating a “zero tolerance” miter bar assembly that is “universal” and can be used with any standard size miter track commonly used and known in the industry.

The angle stops are coupled to the bottom side of the jig body and slidably adjustable along the left side and right side of the jig body. When slid toward the arced slot in the bottom side of the jig body, the angle stops can contact a bolt or pin that has been coupled to the miter bar assembly and protrudes through the arced slot. Once contact is made with the bolt or pin, the angle stops can be secured to the bottom side of the jig body, creating positive stops for quickly rotating the jig to a desired angle. Additionally, the system includes a moveable caliper jaw engaged with the caliper jaw lock, while the stationary caliper jaw or dial indicator is simultaneously secured to the stock carriage. This configuration facilitates precise material removal for a variety of joinery operations, including, but not limited to, pin boards for through-dovetail joinery. In this particular setup, the bottom side of the jig body will be coupled to the miter bar via the center attachment hole adjacent to the lower carriage support.

Performing the method associated with the disclosed device may include the following steps: (1) Clamp workpiece(s) to the stock carriage in desired orientation relative to the stock carriage and associated cutter; (2) Calibrate a “O” point relative to the associated power cutter with caliper coupled to the jig body in order to “track” stock carriage movement; (3) Without engaging the cutter, move clamped workpiece(s) via the rack and pinion mechanism of the device to determine a bound range of stock carriage movement or a starting or stopping point of material removal from workpiece(s); (4) Set and tighten adjustable T-slot stops, or carriage stop assemblies in the T-slot(s) of the stock carriage according to calibrated range of material removal from workpiece(s); and (5) Push device forward and backward over/past power cutter until desired amount of material is removed from workpiece(s), only removing material on forward motion, or as jig is pushed away from operator. It should further be noted that workpiece(s) to be clamped onto stock carriage must be adequately prepared to have flat, true surfaces that can be securely clamped.

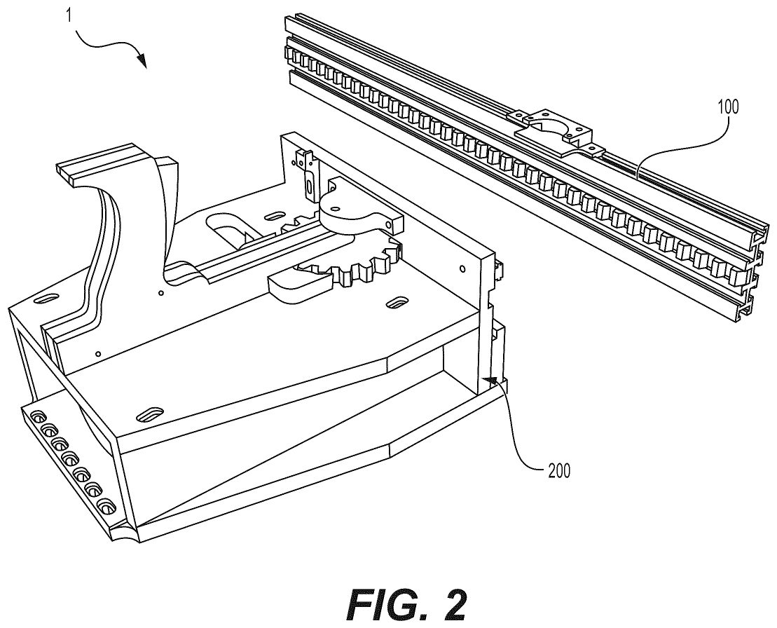

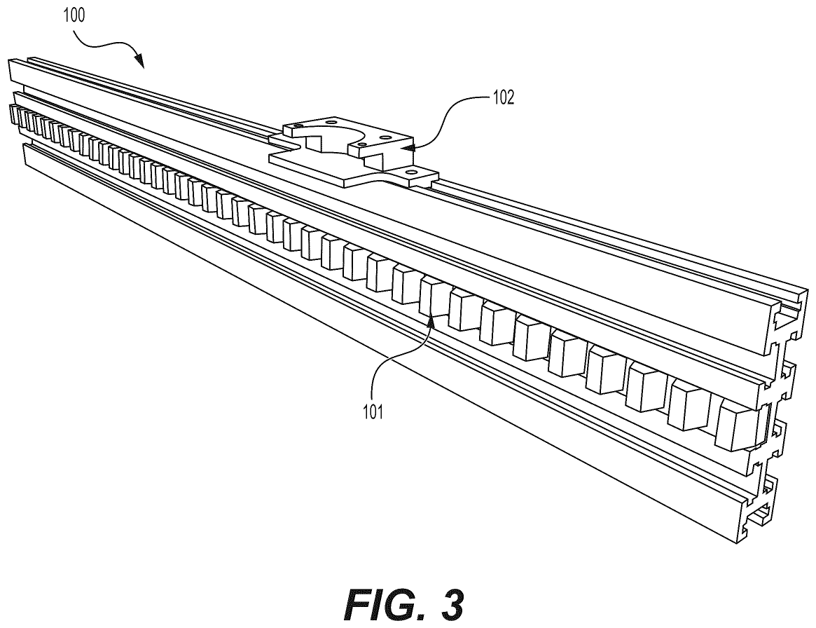

FIG. 1 shows a joinery jig 1 in an assembled state without caliper. FIG. 2 shows the two main elements of the joinery jig 1, a stock carriage 100 and a jig body 200. FIG. 3 shows the components of the stock carriage 100. A rack 101 is affixed to the stock carriage 100 in a center T-slot of the side that couples to the jig body 200. A caliper hold-down assembly 102 is coupled to the stock carriage 100. The caliper hold-down assembly 102 can slide to any location along the top T-slot of the stock carriage 100 before being secured to the stock carriage 100.

The caliper hold-down assembly 102 may include a caliper locking bar (not shown) that freely slides into the top T-slot of the stock carriage 100. A caliper base plate may then be coupled to the caliper locking bar, which “locks” the assembly in place. The caliper hold-down may then be coupled to the caliper base plate, which secures a caliper to the caliper hold-down assembly 102.

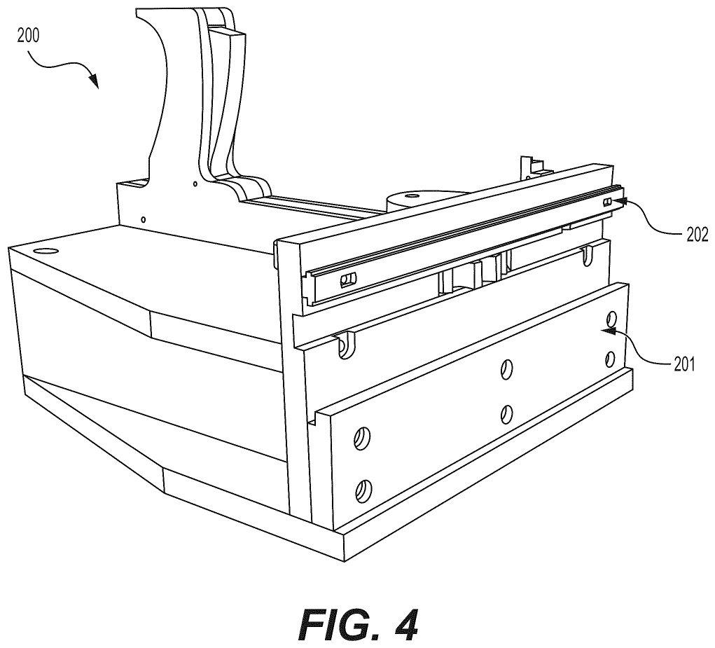

FIG. 4 shows a lower carriage support 201 and an upper carriage support 202 of the jig body 200. The lower carriage support 201 supports the bottom of the stock carriage 100 at a desired height relative to the jig body 200 while also keeping the stock carriage 100 pressed tight to the jig body 200. The upper carriage support 202 keeps the top of the stock carriage 100 pressed tight to the jig body 200 while also preventing the stock carriage 100 from having any “slop” or “play” relative to the jig body 200 while also preventing the stock carriage 100 from lifting off of the lower carriage support 201.

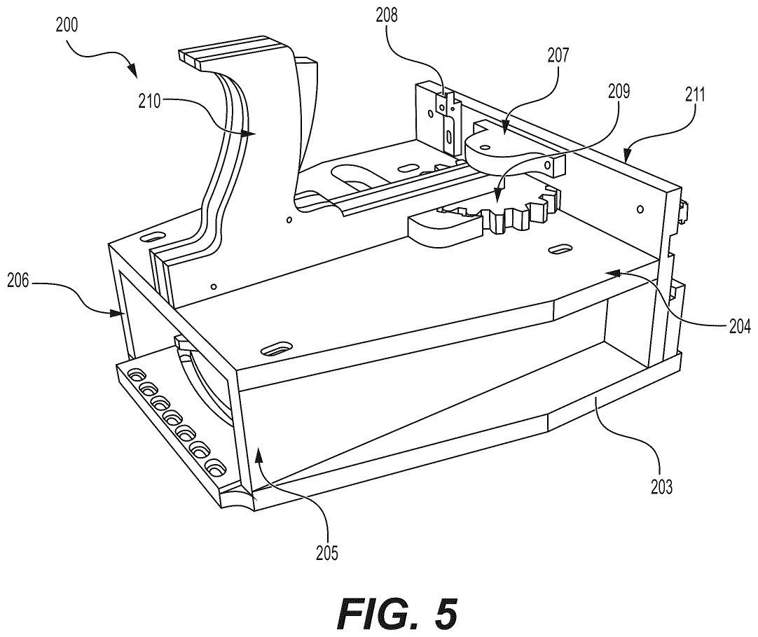

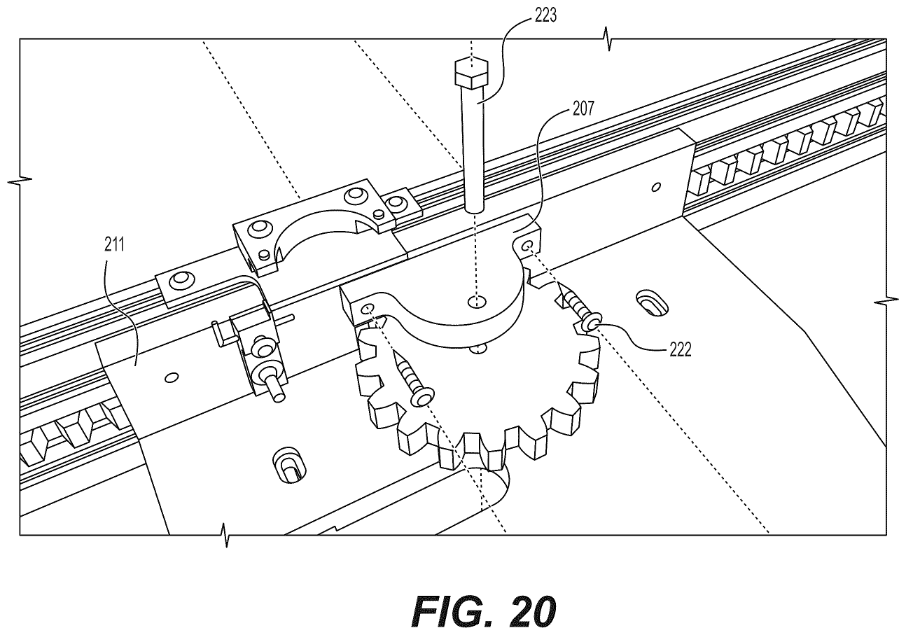

FIG. 5 shows a perspective view of the jig body 200 components. The bottom side 203 and top side 204 are spaced apart in a parallel fashion via the right side 205 and left side 206. The front side 211 is oriented perpendicularly to the bottom side 203 and the top side 204. A pinion axle bracket 207 is coupled to the front side 211 in a manner that allows a handle assembly 210 and a pinion 209 to be retained by a pinion axle 223 (as shown in FIG. 20). A caliper jaw lock 208 is coupled to the front side 211 adjacent to the pinion axle bracket 207.

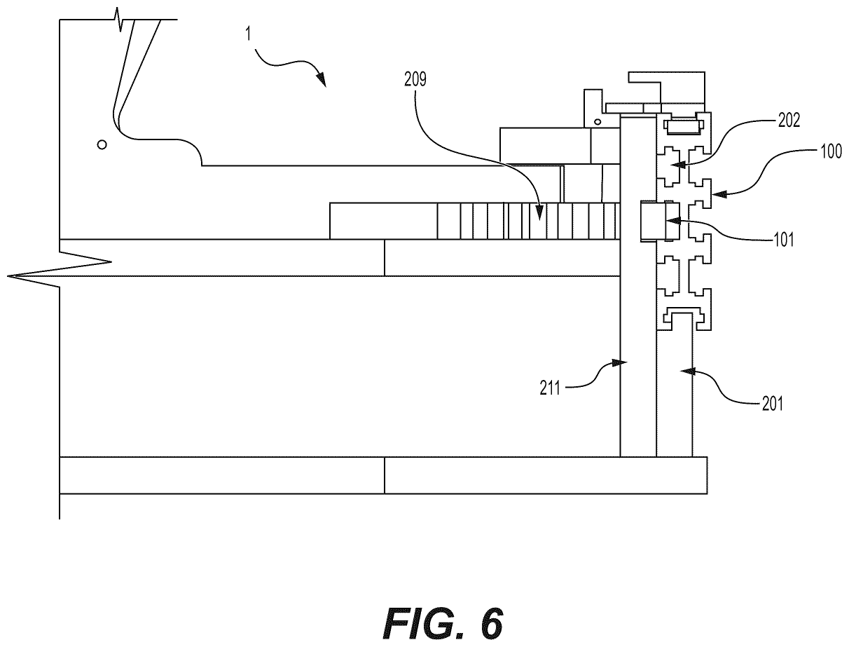

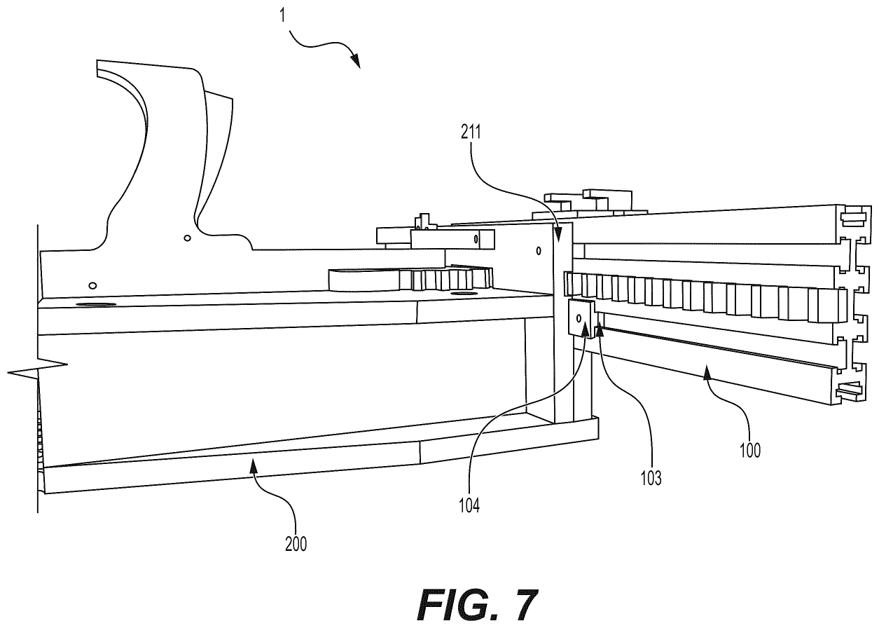

FIG. 6 shows how the joinery jig 1 stock carriage 100 is supported by and held against the front side 211 by the lower carriage support 201 and the upper carriage support 202. The lower carriage support 201 supports the stock carriage 100 at a height necessary to allow the rack 101 to align or “mesh” with the pinion 209. FIG. 7 shows a perspective view of how a carriage stop assembly may be used. A carriage stop locking bar 103 is inserted into a T-slot of the stock carriage 100. A carriage stop 104 is then secured to the carriage stop locking bar 103. This prevents the stock carriage 100 from moving past this position when the carriage stop 104 makes contact with the front side 211 of the jig body 200.

According to an exemplary embodiment, a carriage accessory may be attached to the stock carriage in a parallel orientation with carriage accessory locking bars and carriage accessory hold-down bars (not shown). When the carriage accessory locking bars and carriage accessory hold-down bars are coupled together, the carriage accessory may be firmly secured to the stock carriage.

According to an exemplary embodiment, a stock clamping guide may be attached to the stock carriage with the carriage accessory locking bars (not shown). Two fasteners may be inserted through the slot in the stock clamping guide and into the carriage accessory locking bars. This allows the stock clamping guide to be positioned at a wide range of angles allowing workpiece(s) to be quickly and repeatably aligned on the stock carriage before being clamped to the stock carriage.

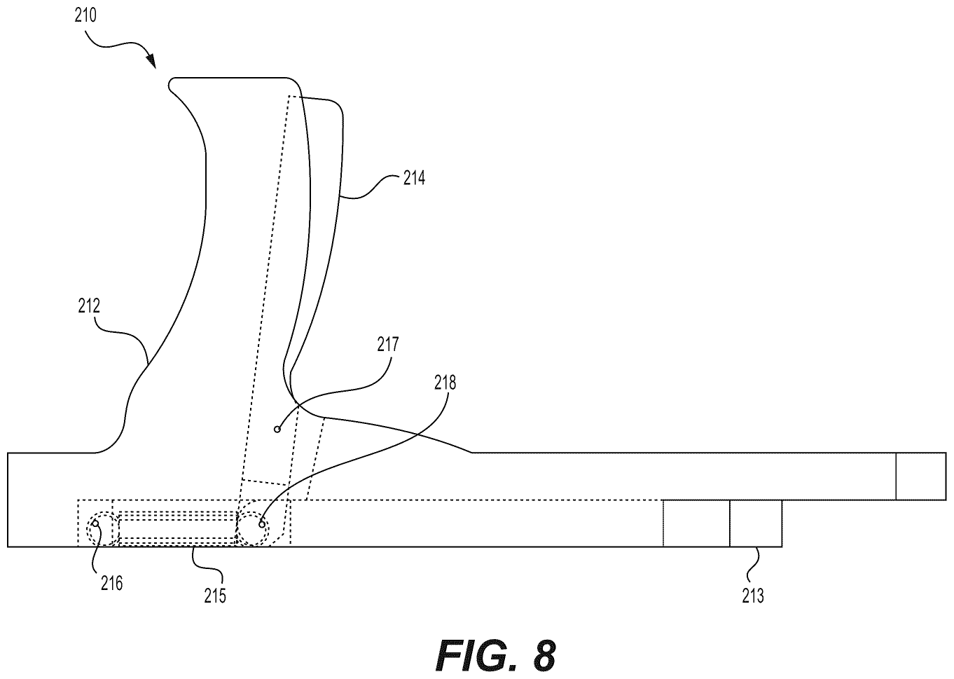

FIG. 8 shows a side view of the handle assembly 210 of the jig body 200. A pinion clutch 213 may slide along a bound range inside the bottom of the handle 212. The pinion clutch 213 may be coupled to a clutch lever 214 via a pinion clutch/clutch lever coupling pin 218. The clutch lever 214 may be coupled to the handle 212 via a clutch lever retaining pin 217. The clutch lever 214 may rotate about the clutch lever retaining pin 217 in a bound range in order to move the pinion clutch forward. The pinion clutch 213 may remain disengaged from the pinion 209 via an extension spring 215 which may be housed in a void in the back of the handle 212 and retained by an extension spring retaining pin 216 and the pinion clutch/clutch lever retaining pin 218. However, embodiments are not limited thereto.

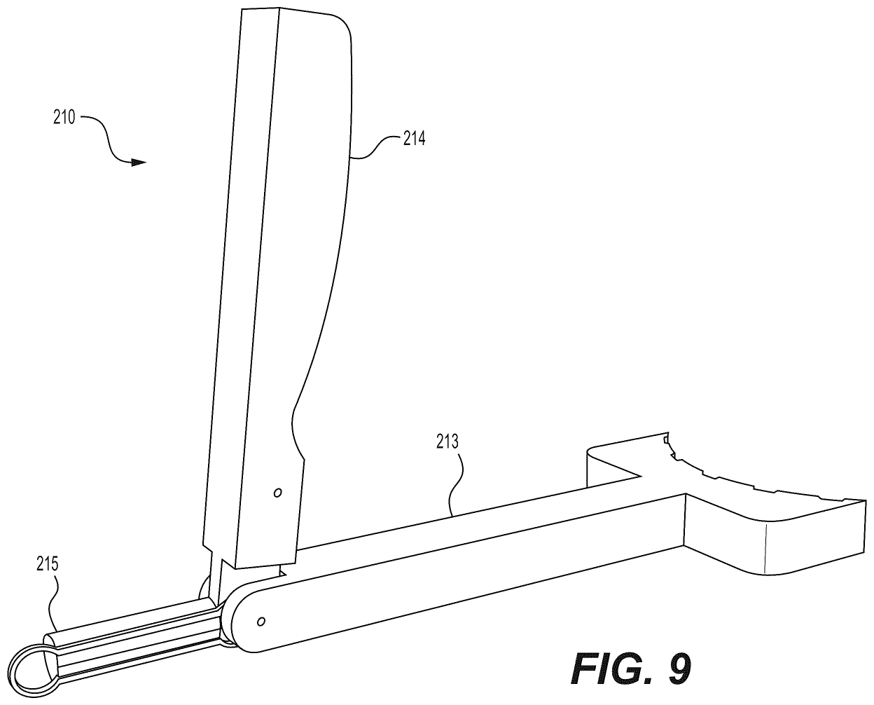

FIG. 9 is a perspective view of the pinion clutch 213, clutch lever 214, and extension spring 215 are related. The pinion clutch 213, clutch lever 214, and extension spring 215 may be coupled at the same point by the pinion clutch/clutch lever coupling pin 218. Knuckles of the pinion clutch 213 and the clutch lever 214 may allow space for one connecting loop of the extension spring 215 to be bound by the pinion clutch/clutch lever coupling pin 218 between aforementioned knuckles.

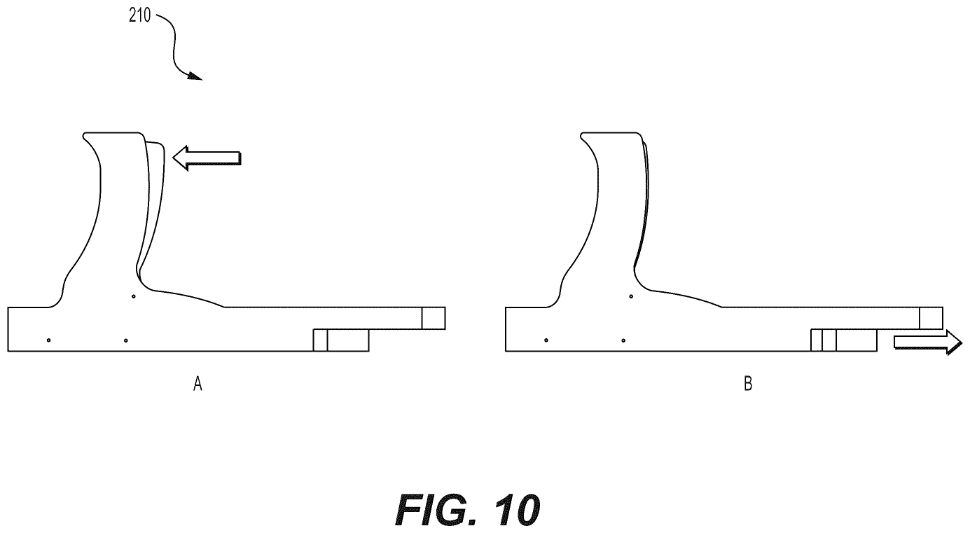

FIG. 10 shows a disengaged position A and engaged position B of the pinion clutch and clutch lever of the handle assembly 210. As the clutch lever is protruding from the handle, the extension spring pulls the pinion clutch into the handle, allowing the pinion to be disengaged from the clutch. As the clutch lever is pressed into the handle, the pinion clutch is forced out of the handle, toward the pinion, to engage the pinion, thus allowing it to be rotated by the handle assembly, thus moving the stock carriage via the rack.

According to an exemplary embodiment, the stock carriage may be coupled to the jig body by an upper cleat and a lower cleat of the stock carriage may slide between an upper cleat and a lower cleat of the jig body (not shown). The respective angles of aforementioned cleats may force the stock carriage tight to the jig body when the upper cleat of the jig body is tightened to the front side of the jig body. This connection may afford the stock carriage slidable freedom of motion only along an axis parallel to the length of the stock carriage.

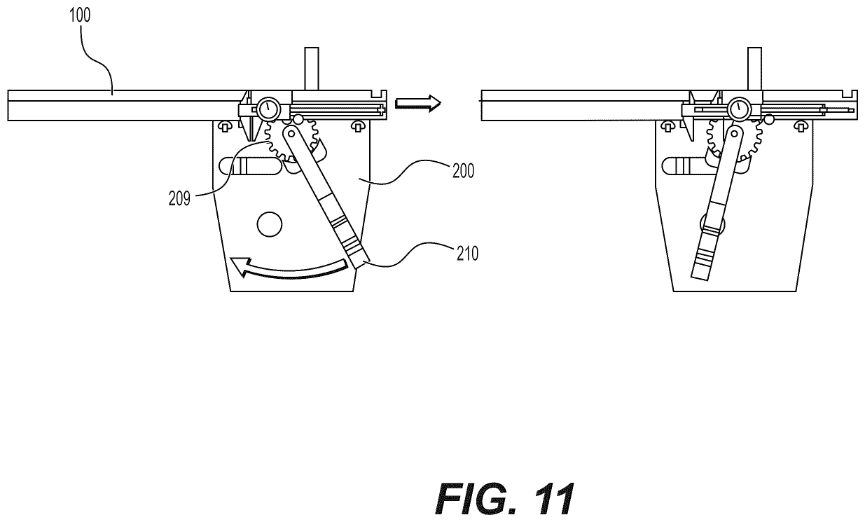

FIG. 11 shows how the handle and clutch mechanism (i.e., the handle assembly 210) may rotate the pinion 209 in order to move the stock carriage 100. When the clutch lever is depressed into the handle, the pinion clutch will engage the teeth of the pinion, as described above with respect to FIGS. 6-10. According to the present exemplary embodiment, the handle can then be rotated about the axle to move the stock carriage toward or away from an associated power cutter. According to an exemplary embodiment, a miter bar (not shown) may be attached to the bottom side of the jig body at various locations and at different angles to orient the jig body for desired joinery procedures.

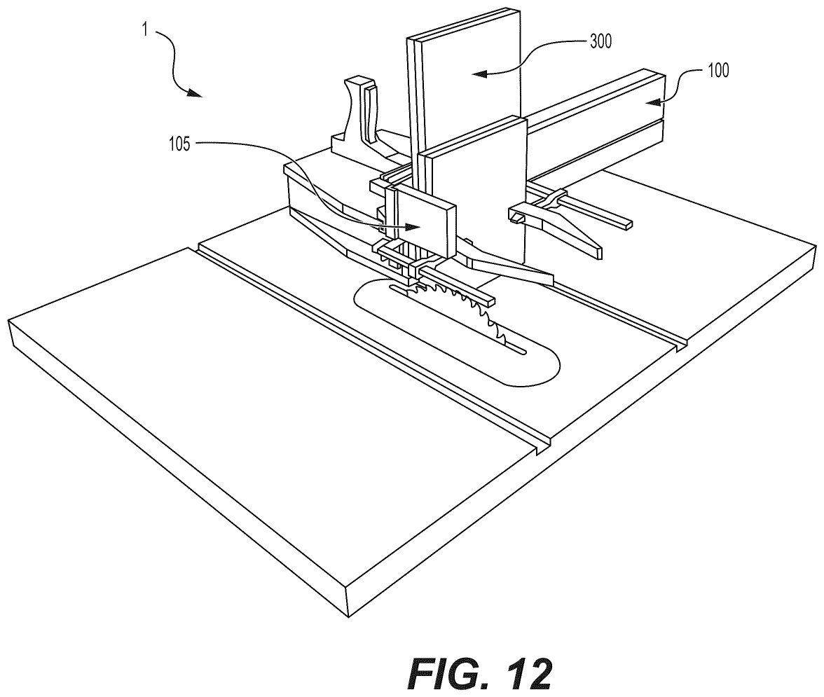

FIG. 12 shows a perspective view of a small workpiece guide stop 105 used to index multiple workpieces 300 relative to the stock carriage 100 of the joinery jig 1. The workpieces 300 may be secured at both edges thereof with T-slot clamps as shown. The workpiece guide stop 105 may provide a reference point for clamping workpiece(s) to the stock carriage 100 or providing an additional clamping surface.

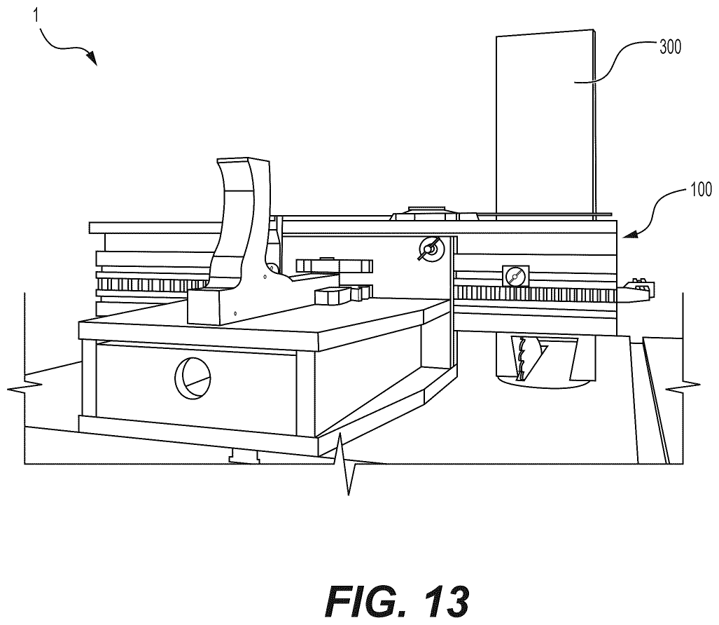

FIG. 13 shows a perspective view of a workpiece 300 clamped parallel to the stock carriage 100 for cutting through-dovetails with a tilted cutter. Adjustable T-slot stops may be tightened in a T-slot of a stock carriage cleat to create a bound range of stock carriage movement relative to the front side of the jig body 200, thus creating a desired distance between the half-tails at the end of the workpiece 300. The workpiece 300 may be turned 180 degrees along a longitudinal axis and reclamped to cut the opposing half-tail. Remaining material between the half-tails may be removed by returning the cutter to 90 degrees relative to the work surface, lowering the cutter height accordingly, and making further “clean up” passes over said cutter.

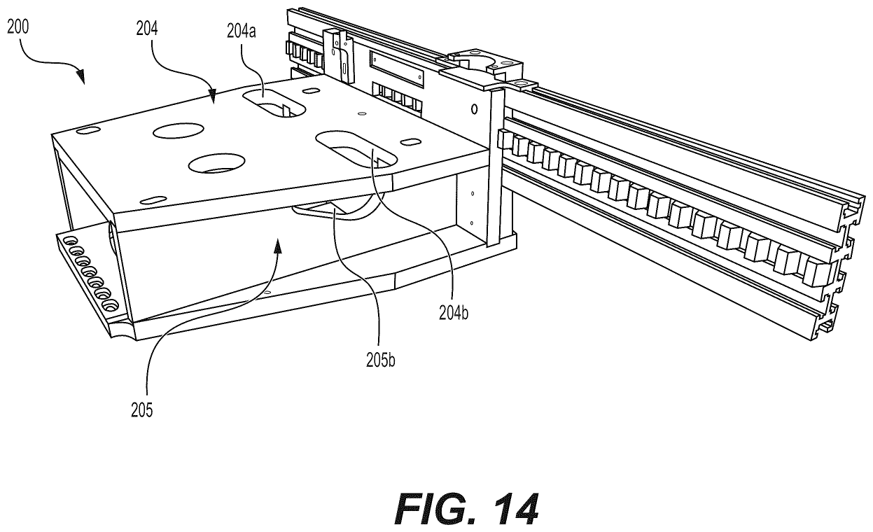

FIG. 14 shows cutouts 204a and 204b in the top side 204 and cutouts 205a (not shown) and 205b in the right side 205 of the jig body 200. Such cutouts create an ergonomic hand-hold for the operator when using the joinery jig 1 on both the right side and left side of an associated power cutter. A matching cutout may be used on the left side of the jig body.

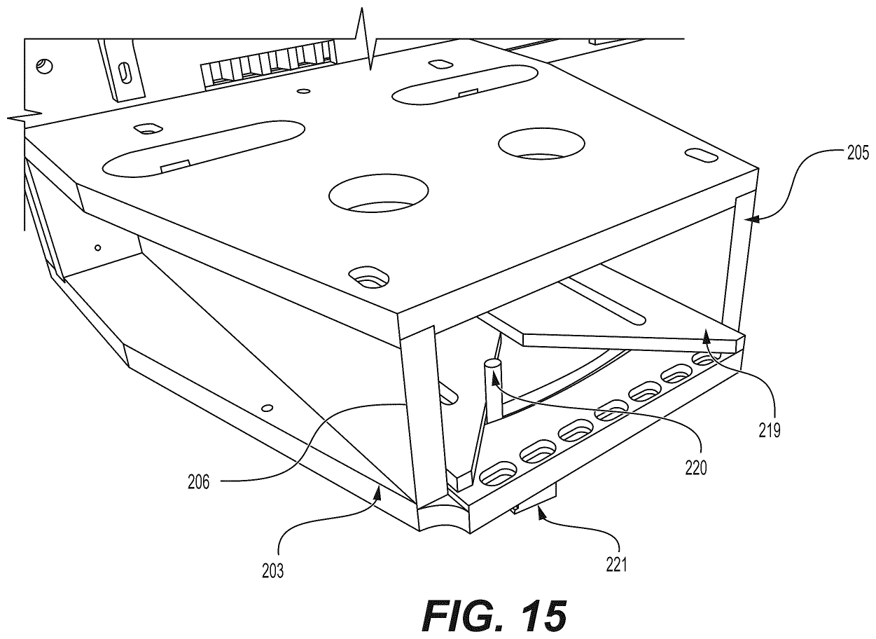

FIG. 15 shows angle stops 219 that may slide on the bottom side 203 of the jig body 200 with a longer edge referencing the right side 205 and left side 206. This orientation provides linear stability when sliding the angle stops 219 on the bottom side 203 to a location where their angled edge will contact a pin 220 that has been secured to the miter bar assembly 221 in order to create positive stops for quickly and repeatably referencing desired angles when pivoting the jig body 200 on the miter bar assembly 221. This setup and method accommodates angles that are commonly used in dovetail joinery.

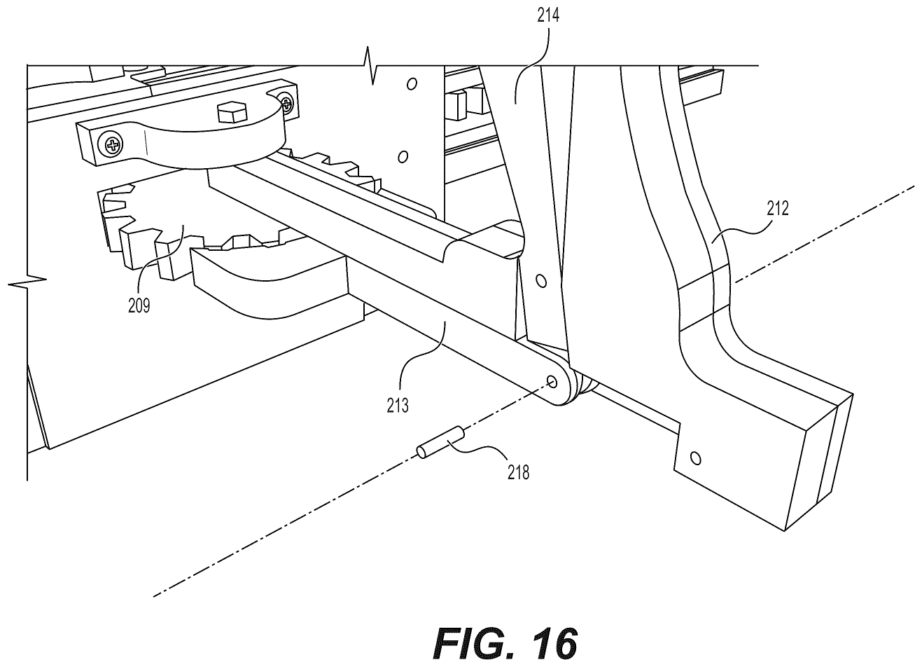

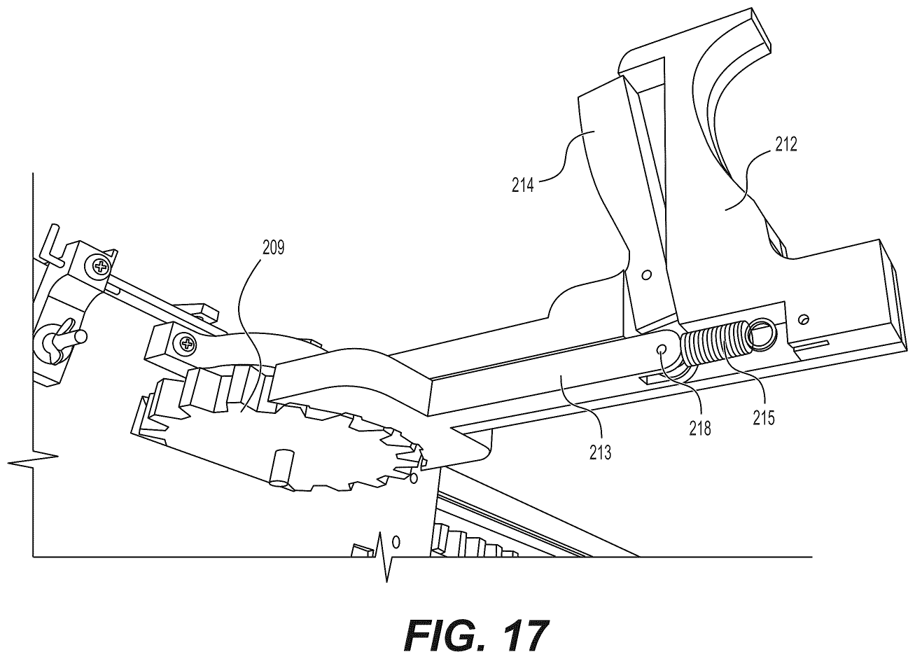

FIG. 16 shows a means of coupling the pinion clutch 213 to the clutch lever 214. The coupling means may be the pin 218. FIG. 17 shows a means of coupling the extension spring 215 to the pinion clutch 213 and at a clutch lever connection point. The coupling means may be the pinion clutch/clutch lever retaining pin 218.

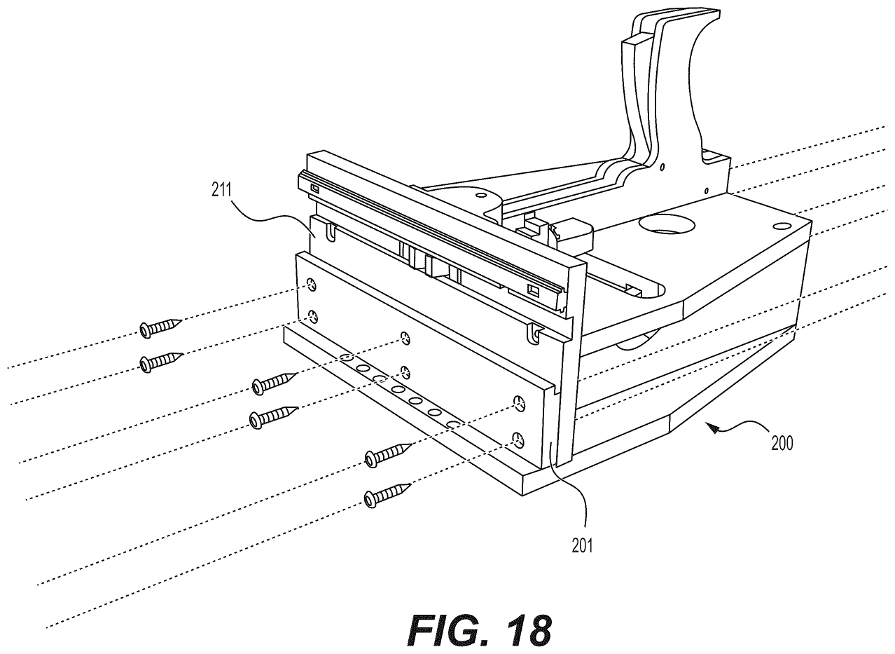

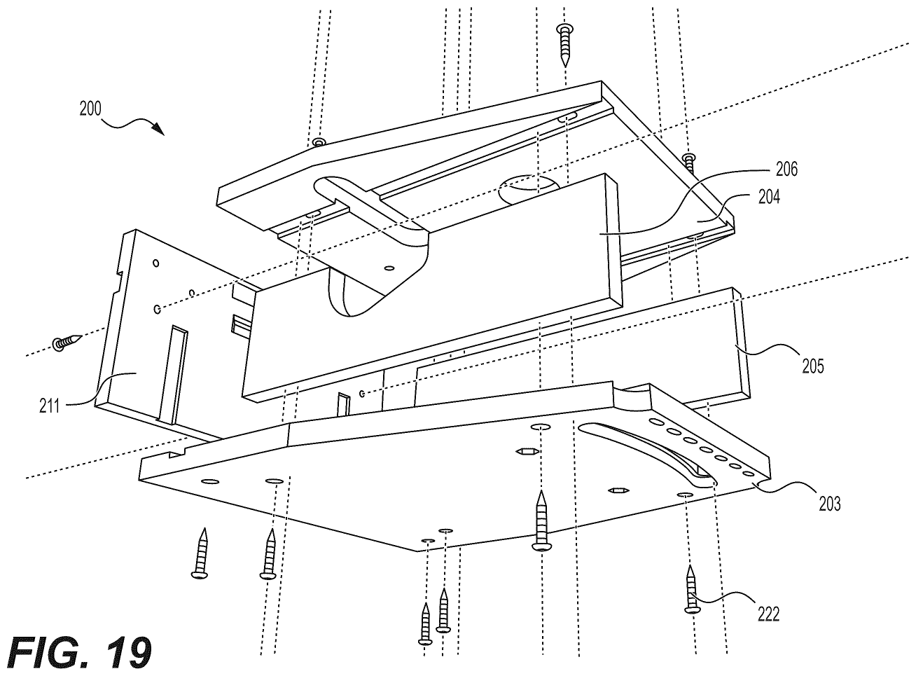

FIG. 18 shows a means of attaching the lower carriage support 201 to the front side of the jig body 200 via countersunk holes into which fasteners 222 may be inserted. FIG. 19 shows a view of a means of assembling the bottom side 203, top side 204, left side 206, right side 205, and front side 211 of the jig body 200 via countersunk holes into which fasteners 222 may be inserted. FIG. 20 shows a means of attaching the pinion axle bracket 207 to the front side 211 of the jig body 200 via countersunk holes into which fasteners 222 may be inserted, and the pinion axle bracket 207 houses one end of the pinion axle 223.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

I claim:

1. A jig assembly, comprising:
a jig body having a front side, a top side, a bottom side, a left side, and a right side, the top side and the bottom side being parallel to each other, the left side and the right side being parallel to each other, and the front side being perpendicular to the top side and bottom side;
a lower carriage support connected to a lower portion of the front side;
an upper carriage support removably coupled to an upper portion of the front side;
a pinion connected to a top of the top side, the pinion configured to spin freely about an axle; and
a pinion axle bracket connected to a back of the front side above the pinion.

2. The jig assembly of claim 1, wherein the pinion is selectively engageable with a rack of a stock carriage to permit controlled movement of the stock carriage relative to the jig body.

3. The jig assembly of claim 2, wherein the jig body further comprises a handle pivotally coupled to the axle,
wherein the pinion is configured to be rotated manually via the handle.

4. The jig assembly of claim 3, wherein the handle comprises a clutch mechanism configured to selectively engage or disengage the pinion.

5. The jig assembly of claim 4, wherein the clutch mechanism comprises a spring-biased pinion clutch operable by a clutch lever positioned on the handle.

6. The jig assembly of claim 2, wherein the pinion axle bracket retains an upper end of the axle and aligns the pinion relative to the rack.

7. The jig assembly of claim 1, wherein the jig body further comprises a caliper jaw lock adjustably connected to the back of the front side adjacent to the pinion axle bracket.

8. The jig assembly of claim 7, wherein the caliper jaw lock is configured to fix a movable jaw of a caliper to the jig body to enable tracking movement of a stock carriage relative to a zero point.

9. The jig assembly of claim 1, wherein the jig body further comprises a miter bar assembly connected to a bottom of the bottom side.

10. The jig assembly of claim 9, wherein the jig body comprises an arcuate slot in the bottom side thereof for pivoting the jig body relative to the miter bar about a fixed point.

11. The jig assembly of claim 10, wherein the arcuate slot is configured to cooperate with a locking knob and thru-bolt assembly to fix the jig body at a desired angular orientation relative to the miter bar.

12. A method of using a jig assembly to machine a workpiece, the method comprising:
providing a jig assembly comprising a jig body, a stock carriage, a rack and pinion mechanism, and a miter bar assembly, wherein the jig assembly is configured to be operatively coupled to a power cutter;
clamping a workpiece to the stock carriage in a desired orientation relative to the stock carriage and the power cutter;
calibrating a “0” point with a caliper coupled to the jig body, the caliper configured to track movement of the stock carriage relative to the power cutter;
moving the clamped workpiece via the rack and pinion mechanism of the jig assembly to determine a bound range of stock carriage movement or a starting or stopping point of material removal from the workpiece without engaging the cutter;
setting and tightening one or more adjustable T-slot stops or carriage stop assemblies in the T-slot of the stock carriage according to the calibrated range of material removal from the workpiece; and
pushing the jig assembly forward and backward over or past the power cutter,
wherein material is removed from the workpiece only on the forward motion or as the jig is pushed away from a user until a desired amount of material is removed from the workpiece.

13. The method of claim 12, wherein the rack and pinion mechanism comprises a pinion connected to the jig body, the method further comprising:
engaging a clutch lever on a handle to rotate the pinion and move the stock carriage incrementally relative to the power cutter; and
releasing the clutch lever to allow free rotation of the handle without engagement of the pinion.

14. The method of claim 13, wherein:
the rack and pinion mechanism further comprises a rack connected to the stock carriage; and
moving the clamped workpiece comprises rotating the pinion engaged with the rack.

15. The method of claim 12, wherein calibrating the “0” point further comprises securing a caliper movable jaw to the jig body using a caliper jaw lock.

16. The method of claim 12, further comprising pivoting the jig assembly about an arcuate slot formed in the jig body to set a desired angular orientation relative to the power cutter.

17. The method of claim 12, wherein pushing the jig assembly over or past the power cutter is performed while maintaining the user's hands on lateral sides of the jig body, away from a cutting path.
